(19) United States
(12) Patent Application Publication
(10) Pub. No.: US 2025/0153726 A1
(43) Pub. Date: May 15, 2025

(54) REMOTE MOVING SYSTEM

(71) Applicant: TOYOTA JIDOSHA KABUSHIKI KAISHA, Aichi (JP)

(72) Inventor: Tatsuya HASHIMOTO, Okazaki-shi (JP)

(21) Appl. No.: 18/937,023

(22) Filed: Nov. 5, 2024

(30) Foreign Application Priority Data
Nov. 9, 2023 (JP) 2023-191352

(51) Int. Cl. B60W 50/10

(52) U.S. Cl. CPC B60W 50/10; B60W 2556/45; B60W 2756/10

(57) ABSTRACT

A remote moving system moves a vehicle by a remote operation using an operation terminal. The remote moving system permits a target vehicle to be moved by the remote operation when a riding condition and a start suppression condition are satisfied. The riding condition is a condition that an operator performing the remote operation rides in a non-target vehicle that is different from the target vehicle which is a vehicle driven by the remote operation. The start suppression condition is a condition that the non-target vehicle is stopped and does not start moving.

### CROSS-REFERENCE TO RELATED APPLICATIONS

This application claims priority to Japanese patent application No. JP 2023-191352 filed on Nov. 9, 2023, the content of which is hereby incorporated by reference in its entirety.

### BACKGROUND

### Field

The present invention relates to a remote moving system.

### Description of the Related Art

There is known a remote moving system in which a user of a vehicle remotely drives the vehicle using an operation terminal (see, for example, JP 2023-114501 A).

It should be noted that a vehicle control relating to a parking of a vehicle is specified by a standard ISO 20900 (Partially automated parking systems: PAPS) and a standard ISO 16787(Assisted parking systems: APS).

When two vehicles are parked relatively close to each other and one of the two vehicles is moved by the remote operation, if the other vehicle is in a drivable state, an operator who is driving the vehicle by the remote operation may not be able to concentrate on the remote operation.

### SUMMARY

An object of the present invention is to provide a remote moving system which allows the operator to concentrate on the remote operation.

A remote moving system according to the present invention comprises an electronic control unit which moves a vehicle by a remote operation using an operation terminal. The electronic control unit is configured to permit a target vehicle to be moved by the remote operation when a riding condition and a start suppression condition are satisfied. The riding condition is a condition that an operator performing the remote operation rides in a non-target vehicle that is different from the target vehicle which is a vehicle driven by the remote operation. The start suppression condition is a condition that the non-target vehicle is stopped and does not start moving.

With the remote moving system according to the present invention, even if the operator who is driving the target vehicle by the remote operation is in the non-target vehicle, the non-target vehicle is in a state where it does not start moving. Therefore, the operator can concentrate on the remote operation to drive the target vehicle and monitoring the target vehicle which the operator drives by the remote operation.

In the remote moving system according to an aspect of the present invention, the riding condition may be a condition that the operator performing the remote operation rides in the non-target vehicle, and a driving apparatus of the non-target vehicle is in an operating state.

When the driving apparatus of the non-target vehicle is in the operating state, the operator is more likely to be unable to concentrate on the remote operation for driving the target vehicle. With the remote moving system according to this aspect of the present invention, when the driving apparatus of the non-target vehicle is in the operating state, the target vehicle is permitted to be driven by the remote operation only when the non-target vehicle is in a state where it does not start moving. Thus, the operator can concentrate on the remote operation for driving the target vehicle.

Further, in the remote moving system according to another aspect of the present invention, the start suppression condition may become satisfied when at least one of (i) a condition that a shift range of the non-target vehicle is set to a parking range, (ii) a condition that the non-target vehicle is held in a stopped state by an electric parking brake device, and (iii) a condition that a brake pedal of the non-target vehicle is operated by the operator and a vehicle moving speed of the non-target vehicle is zero.

With the remote moving system according to this aspect of the present invention, when the shift range of the non-target vehicle is set to the parking range, or when the non-target vehicle is held in a stopped state by the electric parking brake device, or when the brake pedal of the non-target vehicle is operated by the operator and the vehicle moving speed of the non-target vehicle is zero, the target vehicle is permitted to be driven by the remote operation. Therefore, when the non-target vehicle is in a state where it does not start moving, the target vehicle is permitted to be driven by the remote operation. Thus, the operator can concentrate on the remote operation for driving the target vehicle.

A remote moving system according to the present invention comprises an electronic control unit which moves vehicles by a remote operation using an operation terminal. In a situation that two vehicles driven by the remote operation using the same operation terminal are within a distance range in which the two vehicles can be driven by the remote operation, when a start suppression condition that one of the two vehicles is stopped and does not start moving, the electronic control unit is configured to permit the other vehicle to be driven by the remote operation.

With the remote moving system according to the present invention, one vehicle is permitted to be driven by the remote operation only when the other vehicle is not in a state that it does not start moving. Thus, the operator can concentrate on the remote operation for driving the vehicle and monitoring the vehicle which the operator drives by the remote operation.

Elements of the invention are not limited to elements of embodiment and modified examples of the invention described with reference to the drawings. The other objects, features and accompanied advantages of the invention can be easily understood from the embodiment and the modified examples of the invention.

### BRIEF DESCRIPTION OF THE DRAWINGS

FIG. 1 is a view which shows a remote moving system according to an embodiment of the present invention.

FIG. 2 is a view which shows a remote operation device of the remote moving system according to the embodiment of the present invention.

FIG. 3 is a view which shows a vehicle driving assistance apparatus of the remote moving system according to the embodiment of the present invention.

FIG. 4 is a view which shows a flowchart of a routine executed by the remote moving system according to the embodiment of the present invention.

FIG. 5 is a view which shows a flowchart of a routine executed by the remote moving system according to the embodiment of the present invention.

FIG. 6 is a view which shows a scene where a target vehicle is pulled out by the remote moving system according to the embodiment of the present invention.

FIG. 7 is a view which shows a scene where a non-target vehicle is parked by a driver's driving.

FIG. 8 is a view which shows a scene where the target vehicle is parked by the remote moving system according to the embodiment of the present invention.

FIG. 9 is a view which shows a flowchart of a routine executed by the remote moving system according to the embodiment of the present invention.

### DETAILED DESCRIPTION

Below, a remote moving system according to an embodiment of the present invention will be described with reference to the drawings. The technology according to the present invention described below is a technology applicable to a technology conforming to standards ISO20900 (Partially automated parking systems: PAPS) and ISO16787 (Assisted parking systems: APS).

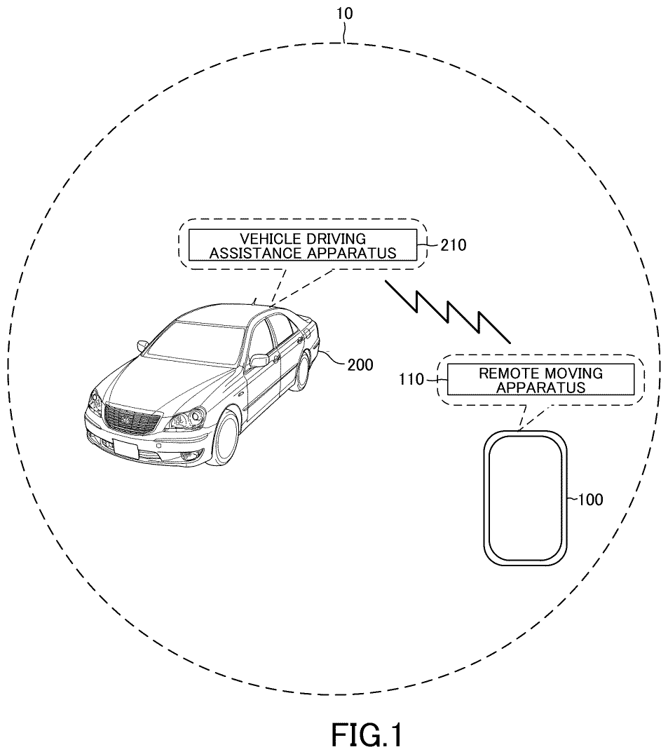

FIG. 1 shows the remote moving system 10 according to the embodiment of the present invention. The remote moving system 10 is a system including a remote moving apparatus 110 and a vehicle driving assistance apparatus 210.

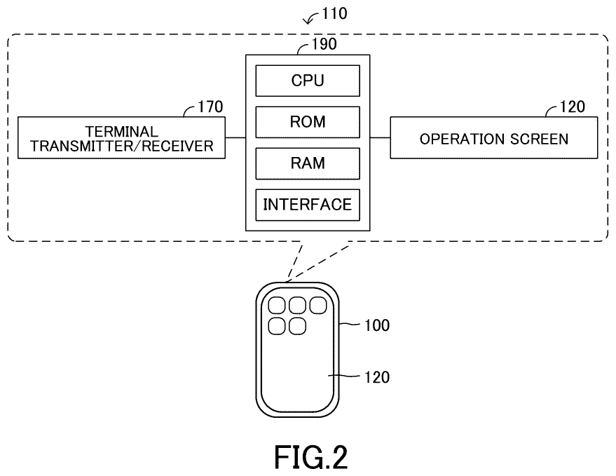

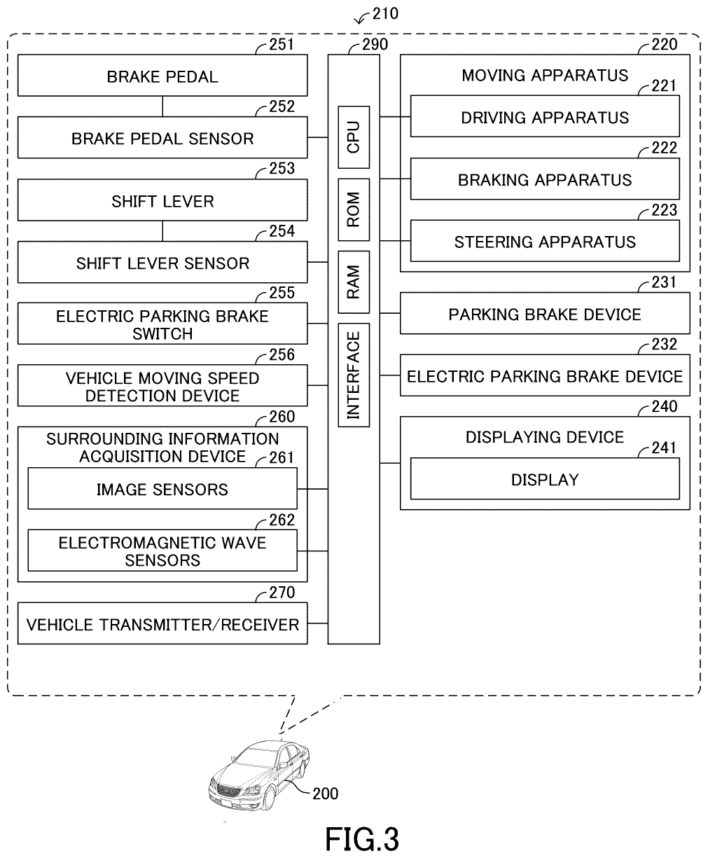

As shown in FIG. 2, the remote moving apparatus 110 is mounted on an operation terminal 100. As shown in FIG. 3, the vehicle driving assistance apparatus 210 is mounted on a vehicle 200.

The operation terminal 100 is a device used by an operator, i.e., a person who intends to drive a vehicle by a remote operation to drive the vehicle by the remote operation. The operation terminal 100 is, for example, a device such as a mobile phone. The remote moving apparatus 110 is an apparatus which causes the vehicle driving assistance apparatus 210 to autonomously move the vehicle by the remote operation, i.e., an operation performed by the operator on the operation terminal 100.

The vehicle driving assistance apparatus 210 is a device which causes the vehicle 200 to autonomously move by the remote operation, i.e., an operation performed on the operation terminal 100 by the operator.

As shown in FIG. 2, the remote moving apparatus 110 includes a terminal ECU 190 as a control device. As shown in FIG. 3, the vehicle driving assistance apparatus 210 includes a vehicle ECU 290 as a control device.

ECU is an electronic control unit. Each of the terminal ECU 190 and the vehicle ECU 290 includes a microcomputer as a main part. The microcomputer includes a computer-readable storage medium such as a CPU, a ROM, a RAM and a non-volatile memory, an interface, and the like. The CPU is configured or programmed to realize various functions by executing instructions, programs, or routines stored in the storage medium. In particular, in the present embodiment, the remote moving apparatus 110 and the vehicle driving assistance apparatus 210 each store, in a storage medium, programs for realizing various kinds of controls and processes executed by the remote moving system 10.

In the present embodiment, the remote moving apparatus 110 and the vehicle driving assistance apparatus 210 each include only one terminal ECU 190, but each of them may include a plurality of ECUs to share the functions of the remote moving apparatus 110.

Further, each of the remote moving apparatus 110 and the vehicle driving assistance apparatus 210 may be configured to be able to update programs stored in the storage medium by wireless communication (for example, Internet communication) with external apparatuses.

As shown in FIG. 2, an operation screen 120 and a terminal transmitter/receiver 170 are mounted on the operation terminal 100.

The operation screen 120 is a display for displaying various images. In addition, the operation screen 120 is a so-called touch screen which can detect that the operator's finger touches the operation screen 120. The operation screen 120 is electrically connected to the terminal ECU 190. The remote moving apparatus 110 displays various images on the operation screen 120. Further, the remote moving apparatus 110 detects that the operator touches the operation screen 120 with a finger by the operation screen 120.

The terminal transmitter/receiver 170 is a device which transmits various wireless signals to an outside of the remote moving apparatus 110 (and thus an outside of the operation terminal 100) and receives various wireless signals coming from the outside. The terminal transmitter/receiver 170 is electrically connected to the terminal ECU 190. The remote moving apparatus 110 transmits the wireless signals to the outside of the remote moving apparatus 110 (and thus the outside of the operation terminal 100) via the terminal transmitter/receiver 170. Further, the remote moving apparatus 110 receives the wireless signals from the outside via the terminal transmitter/receiver 170.

Further, the vehicle 200 is equipped with a moving apparatus 220, a parking brake device 231, an electric parking brake device 232, and a displaying device 240.

The moving apparatus 220 is an apparatus for moving the vehicle 200. The moving apparatus 220 includes a driving apparatus 221, a braking apparatus 222, and a steering apparatus 223.

The driving apparatus 221 is an apparatus that applies a driving force to the vehicle 200. The driving apparatus 221 is electrically connected to the vehicle ECU 90. The vehicle driving assistance apparatus 210 controls the driving force applied to the vehicle 200 by controlling an operation of the driving apparatus 221.

The braking apparatus 222 is an apparatus that applies a braking force to the vehicle 200. The braking apparatus 222 is electrically connected to the vehicle ECU 90. The vehicle driving assistance apparatus 210 controls the braking force applied to the vehicle 200 by controlling an operation of the braking apparatus 222.

The steering apparatus 223 is an apparatus that applies a steering force for steering the vehicle 200 to the vehicle 200. The steering apparatus 223 is electrically connected to the vehicle ECU 90. The vehicle driving assistance apparatus 210 controls the steering force applied to the vehicle 200 by controlling an operation of the steering apparatus 223 to steer the vehicle 200.

The parking brake device 231 is a device that mechanically engages with a transmission gear of the vehicle 200 to hold the vehicle 200 in a stopped state. The parking brake device 231 is electrically connected to the vehicle ECU 90. The vehicle driving assistance apparatus 210 holds the vehicle 200 in the stopped state by the parking brake device 231.

The electric parking brake device 232 is a device that holds the vehicle 200 in the stopped state by holding a brake pad provided on each wheel of the vehicle 200. The electric parking brake device 232 is electrically connected to the vehicle ECU 90. The vehicle driving assistance apparatus 210 holds the vehicle 200 in the stopped state by the electric parking brake device 232.

The displaying device 240 is a device that displays various images to a driver, i.e., the operator riding on the vehicle 200. The displaying device 240 includes a display 241. The displaying device 240 is electrically connected to the vehicle ECU 90. The vehicle driving assistance apparatus 210 displays various images on the display 241 by controlling an operation of the displaying device 240.

Further, the vehicle 200 is equipped with a brake pedal 251, a brake pedal sensor 252, a shift lever 253, a shift lever sensor 254, an electric parking brake switch 255, a vehicle moving speed detection device 256, a surrounding information acquisition device 260, and a vehicle transmitter/receiver 270.

The brake pedal 251 is a device operated by the driver to brake the vehicle 200. The brake pedal sensor 252 is a sensor that detects that the brake pedal 251 is operated. The brake pedal sensor 252 is also a sensor that detects an operation amount of the brake pedal 251. The brake pedal sensor 252 is electrically connected to the vehicle ECU 90. The vehicle driving assistance apparatus 210 recognizes whether or not the brake pedal 251 is operated by the brake pedal sensor 252. Further, the vehicle driving assistance apparatus 210 detects the operation amount of the brake pedal 251 by the brake pedal sensor 252, and controls the operation of the braking apparatus 222 so that the braking force corresponding to the detected operation amount is applied to the vehicle 200.

The shift lever 253 is a device operated by the driver or the operator to set a so-called shift range. The shift lever sensor 254 is a sensor that detects the shift range in which the shift lever 253 is set. The shift lever sensor 254 is electrically connected to the vehicle ECU 90. When the shift lever sensor 254 detects that the shift lever 253 is set to the parking range, the vehicle driving assistance apparatus 210 operates the parking brake device 231 to hold the vehicle 200 in the stopped state.

The electric parking brake switch 255 is a device operated by the driver or the operator to operate the electric parking brake device 232. The electric parking brake switch 255 is electrically connected to the vehicle ECU 90. When the electric parking brake switch 255 is operated while the electric parking brake device 232 is in a non-operating state, the vehicle driving assistance apparatus 210 operates the electric parking brake device 232 to hold the vehicle 200 in the stopped state.

The vehicle moving speed detection device 256 is a device that detects a moving speed of the vehicle 200, and includes, for example, wheel rotation speed sensors provided in each wheel of the vehicle 200. The vehicle moving speed detection device 256 is electrically connected to the vehicle ECU 90. The vehicle driving assistance apparatus 210 acquires the moving speed of the vehicle 200 as a vehicle moving speed V by the vehicle moving speed detection device 256.

The surrounding information acquisition device 260 is a device that acquires information on the vehicle 200. The surrounding information acquisition device 260 includes image sensors 261 and electromagnetic wave sensors 262.

The image sensor 261 is a sensor that captures an image of the surroundings of the vehicle 200 and acquires the image. The image sensor 261 is, for example, a camera. In the following description, the image acquired by the image sensor 261 is referred to as a “camera image”. The image sensors 261 are electrically connected to the vehicle ECU 90. The vehicle driving assistance apparatus 210 acquires the camera images by the image sensors 261.

The electromagnetic wave sensor 262 is a sensor that detects objects existing around the vehicle 200. The electromagnetic wave sensor 262 is, for example, a millimeter wave radar. The electromagnetic wave sensor 262 is electrically connected to the vehicle ECU 90. The vehicle driving assistance apparatus 210 detects the objects existing around the vehicle 200 by the electromagnetic wave sensors 262 and acquires data related to the detected objects.

The vehicle transmitter/receiver 270 is a device that transmits various wireless signals to an outside of the vehicle driving assistance apparatus 210 and receives various wireless signals coming from the outside. The vehicle transmitter/receiver 270 is electrically connected to the terminal ECU 190. The vehicle driving assistance apparatus 210 transmits wireless signals to the outside of the vehicle driving assistance apparatus 210 via the vehicle transmitter/receiver 270. Further, the vehicle driving assistance apparatus 210 receives wireless signals from the outside via the vehicle transmitter/receiver 270.

### <Operations of Remote Moving System>

Next, operations of the remote moving system 10 will be described. The remote moving system 10 causes the vehicle 200 to move by a remote operation using the operation terminal 100. That is, the remote moving system 10 causes the vehicle 200 to move in response to the remote operation, i.e., an operation on the operation terminal 100 (in particular, the operation screen 120) by the operator.

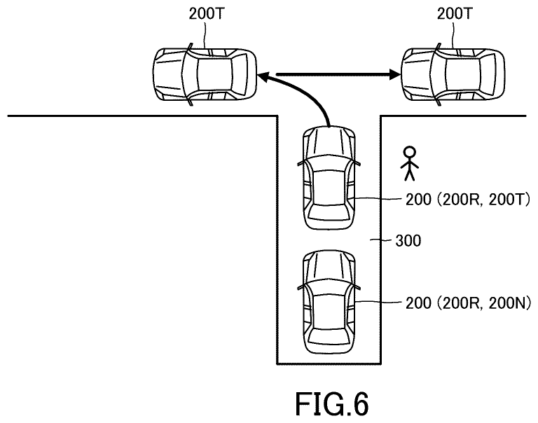

Hereinafter, the operation of the remote moving system 10 will be described by taking cases shown in FIG. 6 to FIG. 8 as examples. In the examples shown in FIG. 6 to FIG. 8, as shown in FIG. 6, two vehicles 200 are stopped in a parking space 300 in a front-rear positional relationship. Each of the vehicles 200 is a vehicle that moves by the remote operation using the same operation terminal 100. However, the vehicle 200 stopped behind may not be a vehicle moved by the remote operation using the operation terminal 100.

In the following explanation, among the two vehicles 200, the vehicle 200 stopped forward is a target vehicle 200T, i.e., a vehicle moved by the remote operation, and the vehicle 200 stopped rear is a non-target vehicle 200N, i.e., a vehicle moved by a manual driving, i.e., a driving by the operator.

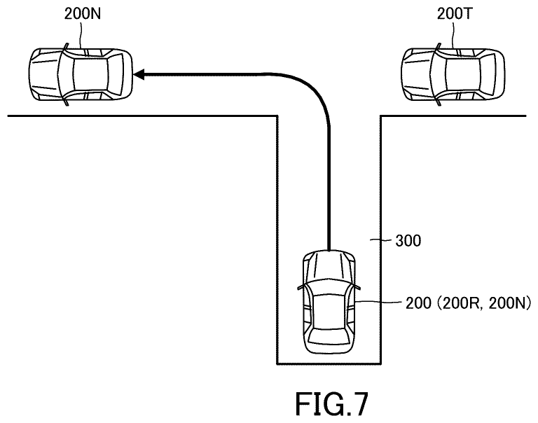

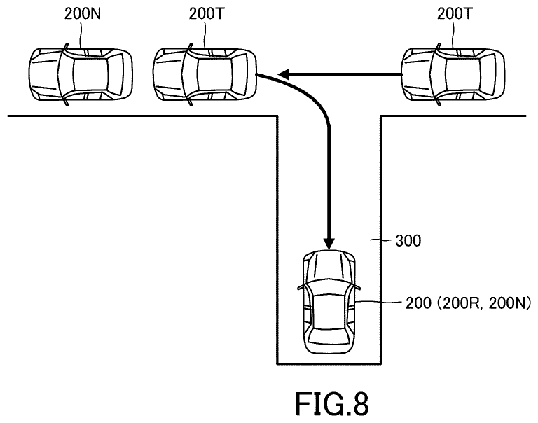

In the examples shown in FIG. 6 to FIG. 8, as shown in FIG. 6, the target vehicle 200T is driven and is pulled out from the parking space 300 by the remote operation while the operator is outside the target vehicle 200T and the non-target vehicle 200N. Then, as shown in FIG. 7, the operator rides on the non-target vehicle 200N, and the non-target vehicle 200N is driven by the manual driving by the operator and is pulled out from the parking space 300. Finally, as shown in FIG. 8, the target vehicle 200T is moved and parked in the parking space 300 by the remote operation while the operator remains riding on the non-target vehicle 200N.

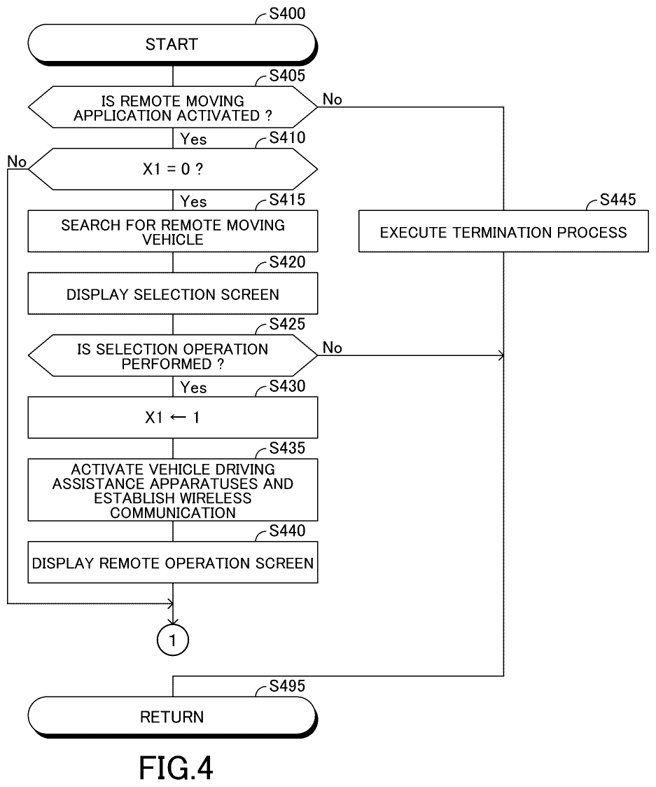

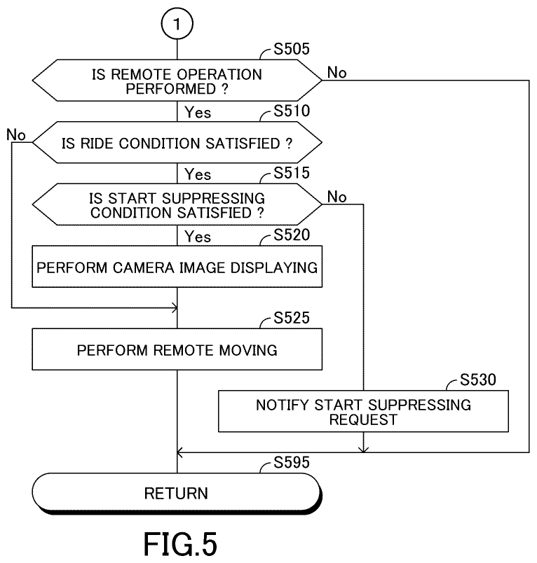

The remote moving system 10 executes routines shown in FIG. 4 and FIG. 5 at predetermined time intervals in order to cause the vehicle 200 to move by the remote operation. Note that processes of steps of the routines shown in FIG. 4 and FIG. 5 may be appropriately performed by any one of the remote moving apparatus 110 of the operation terminal 100, the vehicle driving assistance apparatus 210 of the target vehicle 200T, and the vehicle driving assistance apparatus 210 of the non-target vehicle 200N.

At a predetermined timing, the remote moving system 10 starts executing a process from a step S400 of the routine shown in FIG. 4, proceeds with the process to a step S405, and determines whether or not a remote moving application is activated. The remote move application is an application software installed in the terminal ECU 190 of the operation terminal 100 for causing the vehicles 200 to move by the remote operation.

When the remote moving application is activated, the remote moving system 10 determines “Yes” at the step S405, proceeds with the process to a step S410, and determines whether or not a value of a selection completion flag X1 is “0”. The value of the selection completion flag X1 is set to “0” when a selection of the vehicles 200 to be driven by the remote operation is not completed.

When the value of the selection completion flag X1 is “0” (that is, when the selection of the vehicle to be caused to move by the remote operation is not completed), the remote moving system 10 determines “Yes” at the step S410, proceeds with the process to a step S415, and searches for the vehicle 200 registered in the remote move application, that is, a remote moving vehicle 200R, i.e., the vehicle 200 that can be caused to move by the remote operation. In the examples shown in FIG. 6 to FIG. 8, two vehicles 200 moved by the remote operation using the same operation terminal 100 are within a distance range in which they are caused to move by the remote operation. Accordingly, the two vehicles 200 shown in FIG. 6 to FIG. 8 are respectively recognized as the remote moving vehicle 200R by the search in the step S415.

Then, the remote moving system 10 proceeds with the process to a step S420 and displays a selection screen on the operation screen 120 of the operation terminal 100. The selection screen is a screen for allowing the operator to select the remote moving vehicle 200R to be moved by the remote operation from the recognized remote moving vehicle 200R.

Then, the remote moving system 10 proceeds with the process to a step S425, and determines whether or not a selection operation is performed by the operator. The selection operation is an operation performed by an operator on the selection screen (for example, a touch operation such as a tapping operation) in order to select the remote moving vehicle 200R to be driven by the remote operation.

When the selection operation is not performed by the operator, the remote moving system 10 determines “No” at the step S425, directly proceeds with the process to a step S495, and terminates executing this routine once.

On the other hand, when the selection operation is performed by the operator, the remote moving system 10 determines “Yes” at the step S425, proceeds with the process to a step S430, and sets the selection completion flag X1 to “1”. As a result, the remote moving system 10 determines “No” at the step S410 next time, and directly proceeds with the process to a step S505 of the routine shown in FIG. 5.

In the examples shown in FIG. 6 to FIG. 8, the remote moving vehicle 200R, i.e., the vehicle 200 stopped forward is selected by the selection operation as the remote moving vehicle 200R to be driven by the remote operation.

Next, the remote moving system 10 proceeds with the process to a step S435, and activates the vehicle driving assistance apparatus 210 of the target vehicle 200T, i.e., the remote moving vehicle 200R which is a target to be caused to move by the remote operation, and the vehicle driving assistance apparatus 210 of the non-target vehicle 200N, i.e., the remote moving vehicle 200R which is not a target to be caused to move by the remote operation, and establishes wireless communication between the remote moving apparatus 110 of the operation terminal 100, the vehicle driving assistance apparatus 210 of the target vehicle 200T, and the vehicle driving assistance apparatus 210 of the non-target vehicle 200N.

In the present embodiment, the remote moving system 10 establishes the wireless communication between the remote moving apparatus 110 of the operation terminal 100 and the vehicle driving assistance apparatus 210 of the target vehicle 200T, and also establishes the wireless communication between the vehicle driving assistance apparatus 210 of the target vehicle 200T and the vehicle driving assistance apparatus 210 of the non-target vehicle 200N. However, the remote moving system 10 may be configured to establish the wireless communication between the remote moving apparatus 110 of the operation terminal 100 and the vehicle driving assistance apparatus 210 of the target vehicle 200T, and to establish the wireless communication between the remote moving apparatus 110 and the vehicle driving assistance apparatus 210 of the non-target vehicle 200N. Alternatively, in particular, when the operator rides on the non-target vehicle 200N prior to starting pulling out the target vehicle 200T from the parking space 300, the remote moving system 10 may be configured to establish the wireless communication between the remote moving apparatus 110 of the operation terminal 100 and the vehicle driving assistance apparatus 210 of the non-target vehicle 200N, and to establish the wireless communication between the vehicle driving assistance apparatus 210 of the non-target vehicle 200N and the vehicle driving assistance apparatus 210 of the target vehicle 200T.

When the vehicle driving assistance apparatus 210 of the target vehicle 200T is activated, the driving apparatus 221 of the target vehicle 200T is activated.

Then, the remote moving system 10 proceeds with the process to a step S440 and displays a remote operation screen on the operation screen 120 of the operation terminal 100. The remote operation screen is a screen for causing the operator to perform the remote operation for causing the target vehicle 200T to move.

Next, the remote moving system 10 proceeds with the process to a step S505 of the routine shown in FIG. 5, and determines whether or not the remote operation is performed on the remote operation screen by the operator. The remote operation is an operation (for example, a touch operation of sliding a finger on the remote operation screen) performed by the operator on the remote operation screen in order to cause the target vehicle 200T to move.

When the remote operation is not performed, the remote moving system 10 determines “No” at the step S505, directly proceeds with the process to a step S595, and terminates executing this routine once.

On the other hand, when the remote operation is performed, the remote moving system 10 determines “Yes” at the step S505, proceeds with the process to a step S510, and determines whether or not a ride condition C1 is satisfied.

The ride condition C1 is a condition that the operator rides on the non-target vehicle 200N and the driving apparatus 221 of the non-target vehicle 200N is in an activated condition. The ride condition C1 may be a condition that the operator rides on the non-target vehicle 200N.

It should be noted that the remote moving system 10 determines whether or not the operator rides on the non-target vehicle 200N by the wireless communication between a device such as a so-called smart key corresponding to the non-target vehicle 200N and the vehicle driving assistance apparatus 210 of the non-target vehicle 200N. Of course, the remote moving system 10 may be configured to determine whether or not the operator rides on the non-target vehicle 200N by the wireless communication between the remote moving apparatus 110 of the operation terminal 100 and the vehicle driving assistance apparatus 210 of the non-target vehicle 200N.

In the examples shown in FIG. 6 to FIG. 8, the operator is not in the non-target vehicle 200N and the driving apparatus 221 of the non-target vehicle 200N is not in the activated condition at the time when the process is advanced to the step S510 this time.

Therefore, the remote moving system 10 determines “No” at the step S510, directly proceeds with the process to a step S525, and performs a moving of the target vehicle 200T in response to the remote operation. Then, the remote moving system 10 proceeds with the process to the step S595, and terminates executing this routine once. As a result, the target vehicle 200T is pulled out from the parking space 300 by the remote operation.

Thereafter, the operator rides on the non-target vehicle 200N and activates the driving apparatus 221. Then, as shown in FIG. 7, the operator pulls out the non-target vehicle 200N from the parking space 300 by directly driving the non-target vehicle 200N.

It should be noted that while the non-target vehicle 200N is pulled out from the parking space 300, the remote moving system 10 executes the routines shown in FIG. 4 and FIG. 5 at the predetermined intervals. At this time, the remote moving system 10 starts the process from the step S400, and when the remote moving system 10 proceeds with the process to the step S405, the remote moving application is activated. Therefore, the remote moving system 10 determines “Yes” at the step S405, proceeds with the process to the step S410, and determines whether or not the value of the selection completion flag X1 is “0”.

At this time, the value of the selection completion flag X1 is “1”. Accordingly, the remote moving system 10 determines “No” at the step S410 and proceeds with the process to the step S505 of the routine shown in FIG. 5 to determine whether or not the remote operation is performed.

The remote operation is not performed while the non-target vehicle 200N is pulled out by the manual driving by the operator. Therefore, the remote moving system 10 determines “No” at the step S425, directly proceeds with the process to a step S495, and terminates executing this routine once. While the non-target vehicle 200N is pulled out by the manual driving by the operator, the remote moving system 10 repeatedly executes the above processes. Therefore, the target vehicle 200T is held in a state of being stopped outside the parking space 300.

In the examples shown in FIG. 6 to FIG. 8, the operator performs the remote operation while riding on the non-target vehicle 200N after the non-target vehicle 200N is pulled out from the parking space 300. In this case, the remote moving system 10 operates as follows.

That is, the remote moving system 10 starts the process from the step S400 of the routine shown in FIG. 4, and proceeds with the process to the step S405. At this time, the remote move application is activated. Therefore, the remote moving system 10 determines “Yes” at the step S405, proceeds with the process to the step S410, and determines whether or not the value of the selection completion flag X1 is “0”.

At this time, the value of the selection completion flag X1 is “1”. Accordingly, the remote moving system 10 determines “No” at the step S410, proceeds with the process to the step S505 of the routine shown in FIG. 5, and determines whether or not the remote operation is performed.

At this time, the remote operation is performed. Therefore, the remote moving system 10 determines “Yes” at the step S505, proceeds with the process to the step S510, and determines whether or not the ride condition C1 is satisfied.

At this time, the operator rides on the non-target vehicle 200N, and the driving apparatus 221 of the non-target vehicle 200N is in the activate condition. Therefore, the remote moving system 10 determines “Yes” at the step S510, proceeds with the process to a step S515, and determines whether or not a start suppressing condition C2 is satisfied.

The start suppressing condition C2 is a condition that the non-target vehicle 200N is stopped and does not start moving. More specifically, the start suppressing condition C2 is a condition that the non-target vehicle 200N is stopped, and the non-target vehicle 200N does not start moving even if the driving force is applied to the non-target vehicle 200N from the driving apparatus 221 of the non-target vehicle. In other words, the start suppressing condition C2 is a condition that the non-target vehicle 200N is held in the stopped state.

The start suppressing condition C2 is satisfied when the shift range of the non-target vehicle 200N is set to the parking range (that is, when the non-target vehicle 200N is held in the stopped state by the parking brake device 231). Alternatively, the start suppressing condition C2 is satisfied when the non-target vehicle 200N is held in the stopped state by the electric parking brake device 232. Alternatively, the start suppressing condition C2 is satisfied when the brake pedal 251 is operated by the operator and the vehicle moving speed V of the non-target vehicle 200N is zero (that is, when the braking force is applied to the non-target vehicle 200N by the braking apparatus 222 and the vehicle moving speed V of the non-target vehicle 200N is zero).

When the start suppressing condition C2 is not satisfied (that is, when the non-target vehicle 200N is stopped and does not start moving), the remote moving system 10 determines “Yes” at the step S515, proceeds with the process to a step S520 to perform a camera image displaying. The camera image displaying displays the camera image captured and acquired by the image sensors 261 of the target vehicle 200T on the display 241 of the non-target vehicle 200N. At this time, the remote moving system 10 may be configured to display the camera image also on the operation screen 120 of the operation terminal 100.

Then, the remote moving system 10 proceeds with the process to the step S525, and performs the remote moving. The remote moving is to cause the target vehicle 200T to move in response to the remote operation. That is, the remote moving system 10 permits the target vehicle 200T to move by the remote operation, and causes the target vehicle 200T to move in response to the remote operation.

Thus, in the examples shown in FIG. 6 to FIG. 8, as shown in FIG. 8, the target vehicle 200T is parked in the parking space 300.

Then, the remote moving system 10 proceeds with the process to the step S595, and terminates executing this routine once.

On the other hand, when the start suppressing condition C2 is not satisfied (that is, when the non-target vehicle 200N is moving or the non-target vehicle 200N is stopped but is ready to move), the remote moving system 10 determines “No” at the step S515, proceeds with the process to the step S530, and notifies the operator of a start suppressing request.

The start suppressing request requests the operator to set the non-target vehicle 200N to a non-moving state. That is, the start suppressing request requests the operator to set the non-target vehicle 200N to a state in which the start suppressing condition C2 is satisfied. In the present embodiment, the start suppressing request is made by displaying images requesting the operator set the non-target vehicle 200N to the non-moving state on one or both of the display 241 of the non-target vehicle 200N and the operation screen 120 of the operation terminal 100.

Then, the remote moving system 10 proceeds with the process to the step S495, and terminates executing this routine once.

Thereafter, when the operator sets the non-target vehicle 200N to the non-moving state, the remote moving system 10 determines “Yes” at the step S515, proceeds with the process to a step S525, and performs the remote moving. The remote moving is to cause the target vehicle 200T to move in response to the remote operation.

It should be noted that when the remote moving system 10 determines “No” at the step S405 of the routine shown in FIG. 4 (i.e., when the remote moving application is not activated), the remote moving system 10 proceeds with the process to a step S445, and executes a termination process.

The termination process is a process of (i) setting the vehicle driving assistance apparatus 210 and the driving apparatus 221 of the target vehicle 200T to a non-operating state, (ii) disconnecting the wireless communication between the vehicle driving assistance apparatus 210 of the target vehicle 200T and the vehicle driving assistance apparatus 210 of the non-target vehicle 200N, and (iii) setting the value of the selection completion flag X1 to “0”. It should be noted that when the vehicle driving assistance apparatus 210 of the target vehicle 200T is deactivated, the wireless communication between the remote moving apparatus 110 of the operation terminal 100 and the vehicle driving assistance apparatus 210 of the target vehicle 200T is disconnected.

Then, the remote moving system 10 proceeds with the process to the step S495, and terminates executing this routine once.

The above is the operations of the remote moving system 10.

According to the remote moving system 10, even if the operator who intends to drive the target vehicle 200T by the remote operation, rides on the non-target vehicle 200N, the non-target vehicle 200N does not start moving. Therefore, the operator can concentrate on the remote operation for causing the target vehicle 200T to move and monitoring of the target vehicle 200T being caused to move by the remote operation.

It should be noted that the present invention is not limited to the above-described embodiments, and various modifications can be adopted within the scope of the present invention.

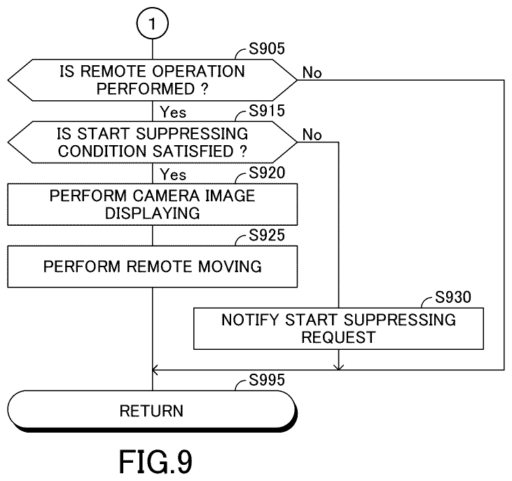

For example, the remote moving system 10 may be configured to execute a routine shown in FIG. 9 instead of the routine shown in FIG. 5.

In this case, the remote moving system 10 displays the remote operation screen at the step S440 of the routine shown in FIG. 4, or determines “No” at the step S410, and then proceeds with the process to a step S905 of the routine shown in FIG. 9, and determines whether the remote operation is performed.

When the remote operation is not performed, the remote moving system 10 determines “No” at the step S905, directly proceeds with the process to a step S995, and terminates executing this routine once.

On the other hand, when the remote operation is performed, the remote moving system 10 determines “Yes” at the step S905, proceeds with the process to a step S915, and determines whether or not the start suppressing condition C2 is satisfied.

When the start suppressing condition C2 is not satisfied (that is, when the non-target vehicle 200N is moving or the non-target vehicle 200N is stopped but is ready to move), the remote moving system 10 determines “No” at the step S915, proceeds with the process to a step S930, and notifies the start suppressing request. Then, the remote moving system 10 proceeds with the process to the step S995, and terminates executing this routine once.

On the other hand, when the start suppressing condition C2 is satisfied (that is, when the non-target vehicle 200N is stopped and does not start moving), the remote moving system 10 determines “Yes” at the step S915, proceeds with the process to a step S920, and performs the camera image displaying. At this time, the remote moving system 10 may be configured to display the camera image also on the operation screen 120 of the operation terminal 100.

Then, the remote moving system 10 proceeds with the process to a step S925, and performs the moving of the target vehicle 200T in response to the remote operation. Then, the remote moving system 10 proceeds with the process to the step S995, and terminates executing this routine once.

According to the remote moving system 10, only when one vehicle 200 (the non-target vehicle 200N) does not start moving, the other vehicle 200 (the target vehicle 200T) is permitted to move. Therefore, the operator can concentrate on the remote operation for moving the target vehicle 200T and the monitoring of the target vehicle 200T moving by the remote operation.

1. A remote moving system, comprising an electronic control unit which moves a vehicle by a remote operation using an operation terminal,
wherein the electronic control unit is configured to permit a target vehicle to be moved by the remote operation when a riding condition and a start suppression condition are satisfied,
wherein the riding condition is a condition that an operator performing the remote operation rides in a non-target vehicle that is different from the target vehicle which is a vehicle driven by the remote operation, and
wherein the start suppression condition is a condition that the non-target vehicle is stopped and does not start moving.

2. The remote moving system according to claim 1, wherein the riding condition is a condition that the operator performing the remote operation rides in the non-target vehicle, and a driving apparatus of the non-target vehicle is in an operating state.

3. The remote moving system according to claim 1, wherein the start suppression condition becomes satisfied when at least one of (i) a condition that a shift range of the non-target vehicle is set to a parking range, (ii) a condition that the non-target vehicle is held in a stopped state by an electric parking brake device, and (iii) a condition that a brake pedal of the non-target vehicle is operated by the operator and a vehicle moving speed of the non-target vehicle is zero.

4. A remote moving system, comprising an electronic control unit which moves vehicles by a remote operation using an operation terminal,
wherein, in a situation that two vehicles driven by the remote operation using the same operation terminal are within a distance range in which the two vehicles can be driven by the remote operation, when a start suppression condition that one of the two vehicles is stopped and does not start moving, the electronic control unit is configured to permit the other vehicle to be driven by the remote operation.
